(19) United States
(12) Patent Application Publication
(10) Pub. No.: US 2019/0288452 A1
(43) Pub. Date: Sep. 19, 2019

(54) Locking Electrical Connector

(71) Applicant: Tyco Electronics France SAS, Pontoise (FR)

(72) Inventors: Steven Lord, Eragny Sur Oise (FR); Xavier Rouillard, Franconville (FR)

(73) Assignee: Tyco Electronics France SAS, Pontoise (FR)

(21) Appl. No.: 16/358,016

(22) Filed: Mar. 19, 2019

(30) Foreign Application Priority Data
Mar. 19, 2018 (FR) 1852329

(51) Int. Cl. H01R 13/639

(52) U.S. Cl. CPC H01R 13/639

(57) ABSTRACT

An electrical connector comprises a housing and a spring mounted on the housing. The spring is a shaped-wire spring having a pair of ends that are mounted on the housing in an axially offset manner in relation to one another. A misalignment of the ends of the spring forms a torsion spring.

### CROSS-REFERENCE TO RELATED APPLICATION

This application claims the benefit of the filing date under 35 U.S.C. § 119(a)-(d) of French Patent Application No. 1852329, filed on Mar. 19, 2018.

### FIELD OF THE INVENTION

The present invention relates to an electrical connector and, more particularly, to an electrical connector capable of locking with a mating connector and preventing locking in the case of a poor connection with the mating connector.

### BACKGROUND

In the field of electrical connections for the motor vehicle industry, connectors comprising spring locking systems are used. A spring is arranged in the connector in such a way as to push a mating connector back when an attempt is made to couple the connector to the mating connector, as long as the force applied to the connector and/or the mating connector is not sufficient to produce a complete plug connection. In such connectors, the spring is unstressed or pre-loaded before any attempt at connection to a mating connector, and is loaded during an attempt at coupling to the mating connector. Thus, as long as the force exerted for coupling the two mating connectors is not sufficient to enable the locking of the two mating connectors to one another, the spring load makes it possible to push the mating connector back in a direction opposite the coupling direction, thus avoiding the possibility of a poor connection.

These spring locking systems usually comprise at least one helical-type spring, as described in the prior art FR 3013911 A1 and FR 3013912 A1. In order to obtain the desired functionality of the spring for electrical connectors such as pyrotechnic connectors, or primer connectors, it is known to employ one or more springs with a high number of turns. Accordingly, the electrical connectors must be equipped with housings which are provided with the space necessary for accommodating therein these springs having the high number of turns.

In order to improve the compactness of the electrical connectors, however, in particular of the connectors for a motor vehicle airbag primer system, it is necessary to reduce the space occupied by the springs in the locking electrical connectors. The prior art FR 3010841 A1 proposes to reduce the overall dimensions and cost of locking electrical connectors by virtue of the use of a shaped-wire flexing spring, also called a profiled-wire spring or shape-wire spring, rather than using one or more helical torsion springs.

### SUMMARY

An electrical connector comprises a housing and a spring mounted on the housing. The spring is a shaped-wire spring having a pair of ends that are mounted on the housing in an axially offset manner in relation to one another. A misalignment of the ends of the spring forms a torsion spring.

### BRIEF DESCRIPTION OF THE DRAWINGS

The invention will now be described by way of example with reference to the accompanying Figures, of which:

FIG. 1 is an exploded perspective view of an electrical connector according to an embodiment;

FIG. 2 is a perspective view of a spring of the electrical connector;

FIG. 3 is a top view of a spring according to another embodiment;

FIG. 4 is a top view of a spring according to another embodiment;

FIG. 5A is a side view of a housing of the electrical connector;

FIG. 5B is a sectional front view of the housing of FIG. 5A;

FIG. 6A is a side view of a housing according to another embodiment;

FIG. 6B is a sectional front view of the housing of FIG. 6A;

FIG. 7 is a perspective view of the electrical connector in a first position;

FIG. 8 is a perspective view of the electrical connector in a second position; and

FIG. 9 is a perspective view of the electrical connector in the first position and mated with a mating connector.

### DETAILED DESCRIPTION OF THE EMBODIMENTS

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will convey the concept of the invention to those skilled in the art.

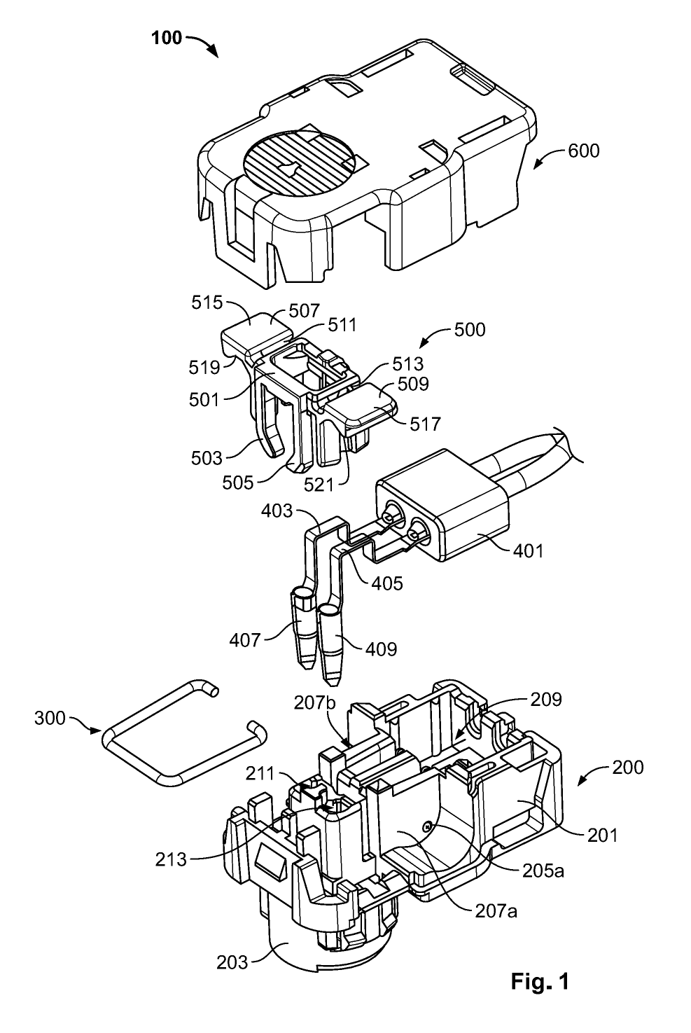

A electrical connector 100 according to an embodiment is shown in FIG. 1. In the shown embodiment, the connector 100 is a connector of a motor vehicle airbag primer system which can be coupled to a mating connector. The electrical connector 100 is configured to be ejected automatically when it is poorly inserted or not fully coupled to a mating connector. In other embodiments, the connector 100 could be another type of connector.

The electrical connector 100, as shown in FIG. 1, includes a housing 200 with a main part 201 substantially perpendicular to a cylindrically shaped connection part 203 which is configured to be connected to a mating connector. The main part 201 of the housing 200 has a pair of recesses 205a, 205b each having a circular shape (only the reference 205a is visible in FIG. 1) and disposed respectively at each lateral surface 207a and 207b of the main part 201. In another embodiment, the recesses 205a, 205b may be passageways. The recesses 205a, 205b are configured to receive ends of a spring 300. The main part 201 of the housing 200 has a cavity 209 adapted to receive a filtering ferrite 401 through which a pair of electrical conductors 403, 405 extend. Each of the electrical conductors 403, 405 has one of a pair of terminals 407, 409. The connection part 203 of the housing 200 has a pair of casings 211, 213 configured to receive the terminals 407, 409.

The electrical connector 100, as shown in FIG. 1, comprises a mobile connector position assurance element 500 (also referred to as a CPA) making it possible, when the electrical connector 100 is correctly locked onto a mating connector, to lock the electrical connector 100 with the mating connector. The CPA 500 has a contact surface 501 from which a pair of locking prongs 503, 505 extend. The contact surface 501 of the CPA 500 is provided on either side with a pair of wings 507, 509 which extend in the same plane as the contact surface 501. The respective joints between the wings 507, 509 and the contact surface 501 are grooves 511, 513 dimensioned in such a way as to receive the spring 300. The two wings 507, 509 of the CPA 500 are equipped with a pair of upper faces 515, 517 opposite a pair of lower faces 519, 521. The upper faces 515, 517 face a cover 600 of the connector 100 and the lower faces 519, 551 face the main part 201 of the housing 200. The cover 600 is formed from an insulating material, and in an embodiment, is formed from a plastic material.

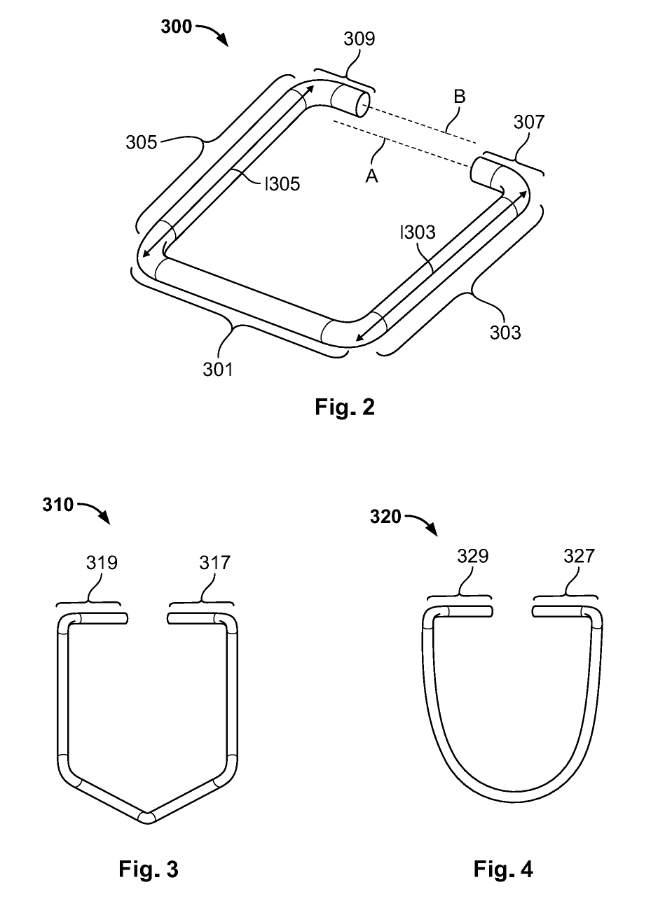

The spring 300, according to an embodiment shown in FIG. 2, is a shaped wire, in particular a round wire. In other embodiments of the invention, the spring 300 could be shaped as a flat wire, as a wire with a rectangular cross-section or as a wire with a square cross-section. The spring 300 is “U”-shaped, having a central part 301 perpendicular to a pair of lateral parts 303, 305. Ends 307, 309 of the lateral parts 303, 305 are folded perpendicularly to the two lateral parts 303, 305. In the embodiment shown in FIG. 2, the lateral parts 303, 305 have the same length such that l303=l305. However, in another embodiment, the two lateral parts 303, 305 could be of different lengths, such that l303>l305 or l303<l305.

The spring 300 does not have turns, which improves the compactness of the electrical connector 100. Moreover, even without turns, the spring 300 is capable of providing a sufficient force permitting the ejection of the mating connector as long as the connectors are not correctly locked onto each other, by virtue of the shape and the mounting of the spring 300. Because the axes A, B of the ends 307, 309 of the spring 300 are misaligned, the shaped-wire spring 300 is capable of behaving like a torsion spring.

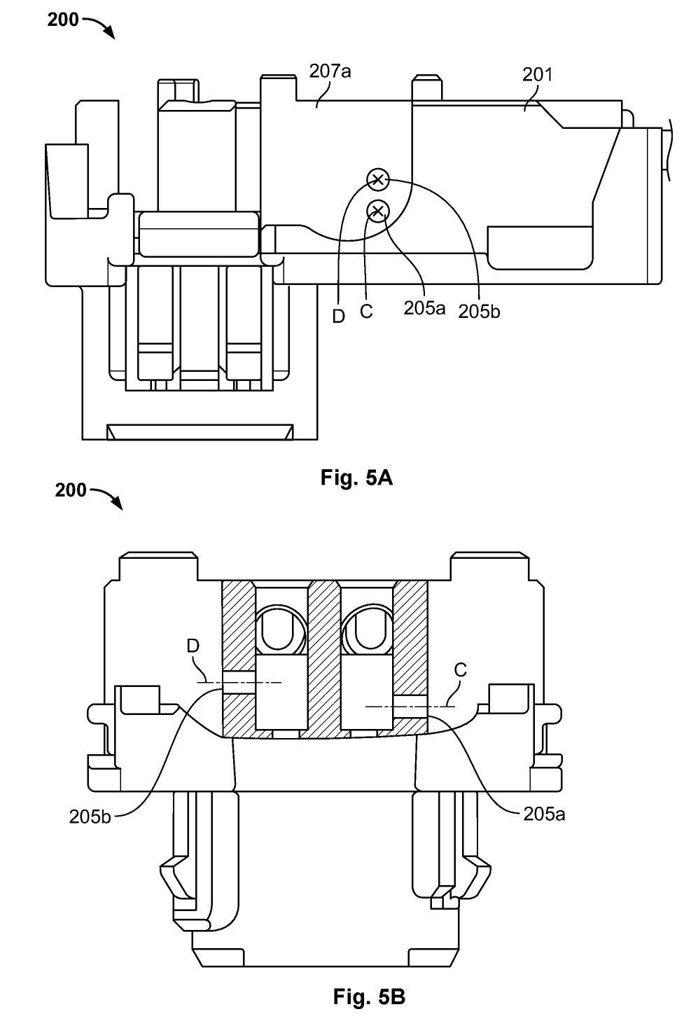

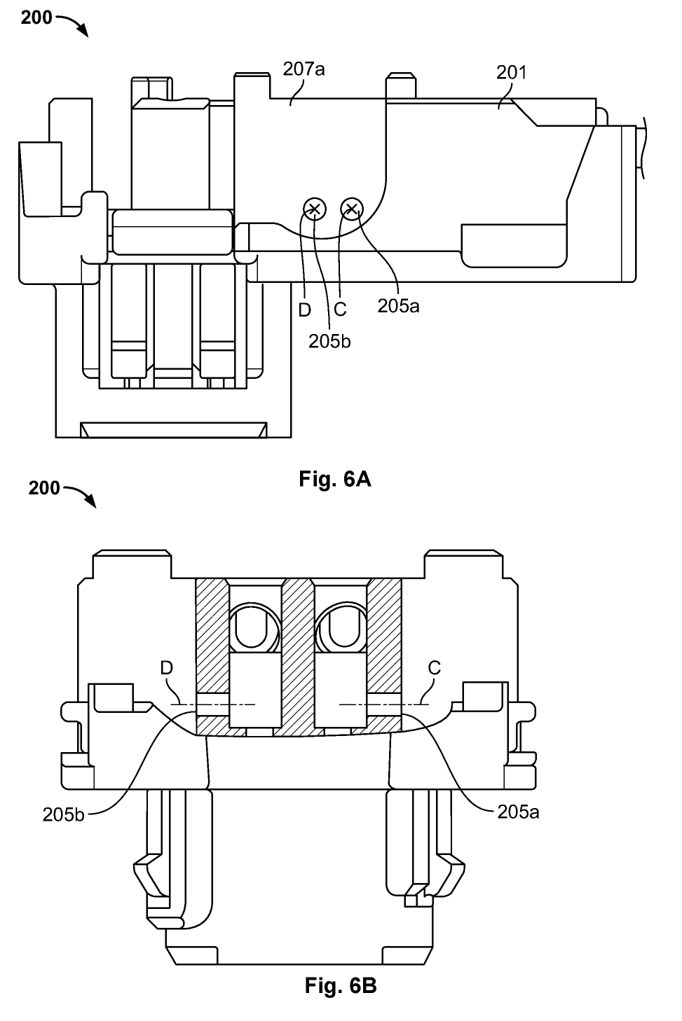

As shown in FIG. 2, the axes A, B are parallel to each other but are not aligned with one another. Thus, the two ends 307, 309 of the spring 300 are axially offset parallel to one another. The misalignment of the two ends 307, 309 of the spring 300 makes it possible to act as a torsion spring. The misalignment of the recesses 205a, 205b in which the ends 307, 309 of the spring 300 are accommodated will be described further with reference to FIGS. 5A-6B. In another embodiment, the difference in lengths l303, l305 between the two lateral parts 303, 305 of the spring 300, such that l303≠l305, can provide the necessary misalignment between the two ends 307, 309 of the spring 300 in order to form a torsion spring.

In another embodiment of a spring 310 shown in FIG. 3, the spring 310 is substantially “V”-shaped and the ends 317, 319 of the spring 310 are axially offset parallel to one another, in such a way that the spring 310 behaves like a torsion spring.

In another embodiment of the spring 320 shown in FIG. 4, the spring 320 has a horseshoe shape or an arc shape and the ends 327, 399 of the spring 300 are axially offset parallel to one another, in such a way that the spring 300 behaves like a torsion spring.

As shown in FIGS. 5A and 5B, in the housing 200, the recess 205a has an axis C and the recess 205b has an axis D. FIGS. 5A and 5B show the misalignment of axes C, D of the recesses 205a, 205b in which the ends 307, 309 of the spring 300 are intended to be mounted. The axes C, D of the recesses 205a, 205b are thus axially offset in relation to one another. In the shown embodiment, the axes C and D of the recesses 205a, 205b are axially offset parallel to one another. In another embodiment, the axes C and D could be misaligned by a predetermined angle formed by the axes C and D which is different from 180°.

The recesses 205a, 205b of the housing 201 and the ends 307, 309 of the spring 300 are dimensioned so as to be assembled together, in particular in a mobile manner such that the end 307 of the spring 300 is mounted in a manner secured in rotation at the recess 205a and that the end 309 of the spring 300 is mounted in a manner secured in rotation at the recess 205b. Thus, when the spring 300 is assembled on the housing 200, the axis A of the end 307 of the spring 300 is aligned with the axis C of the recess 205a of the housing 200, and the axis B of the end 309 of the spring 300 is aligned with the axis D of the recess 205b.

In a housing 200 according to another embodiment, as shown in FIGS. 6A and 6B, the lateral parts 303, 305 of the spring 300 are of different lengths such that l303>l305. The axes C and D of the recesses 205a, 205b are axially offset parallel to one another in such a way that the offset between the axes C and D correspond to the offset between the lengths l303 and l305 of the lateral parts 303, 305 of the spring 300.

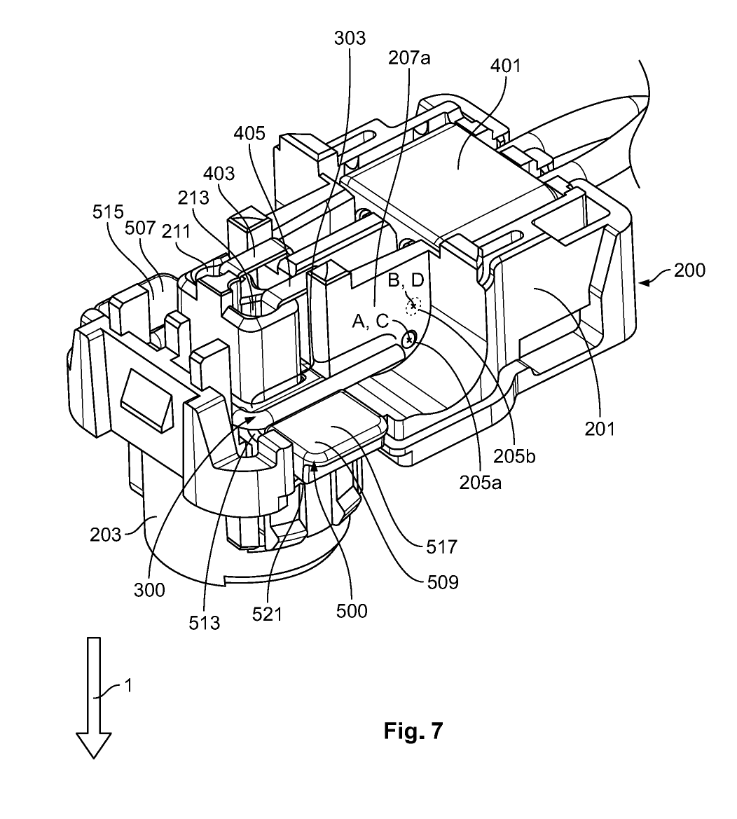

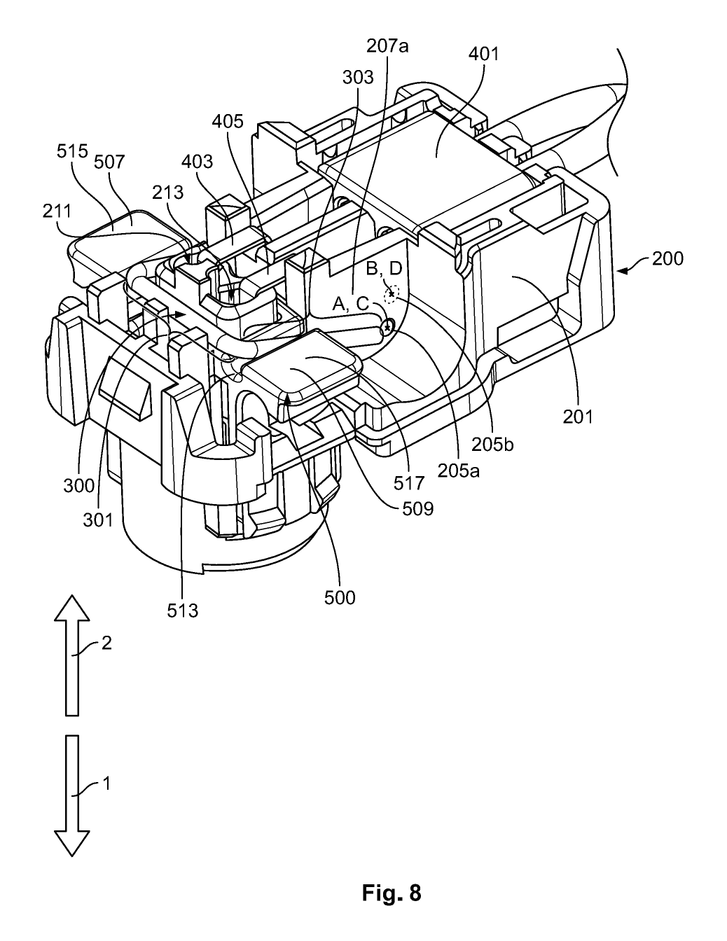

FIG. 7 shows the electrical connector 100 in a first position in which the spring 300 can be unstressed or pre-loaded, and FIG. 8 shows the electrical connector 100 in a second position in which the spring 300 is loaded. The connector mated with the connector 100 and the cover 600 are not shown in FIGS. 7 and 8. In the first and second positions shown in FIGS. 7 and 8, the filtering ferrite 401 is accommodated in the cavity 209 of the housing 200 and the terminals 407, 409 of the electrical conductors 403, 405 are inserted in the intended casings 211, 213 of the housing 200.

In this first position shown in FIG. 7, the CPA device 500 is located in a low position since it is inserted fully into the housing 200 at the cylindrical part 203 such that the lower faces 519, 521 of the two wings 507, 509 of the CPA 500 are in direct contact with the main part 201 of the housing 200. The spring 300 is positioned flat and the lateral parts 303, 305 are accommodated in the grooves 511, 513 of the CPA device 500. When the electrical connector 100 is without a mating connector in the first position, as shown in FIG. 7, the spring 300 is in an unstressed state; the spring 300 is in, or close to, its position of equilibrium.

In another embodiment, the spring 300 in the first position could be in a so-called pre-loaded state. The spring 300 then rests on the CPA device 500 at the grooves 511, 513 of the CPA 500, exerting a force on the connector position assurance element 500 in a coupling direction shown by the arrow 1. This pre-loaded state of the spring 300 makes it possible to ensure the positioning of the connector position assurance element 500 and to maintain it, in particular in environments subjected to vibrations and/or impacts.

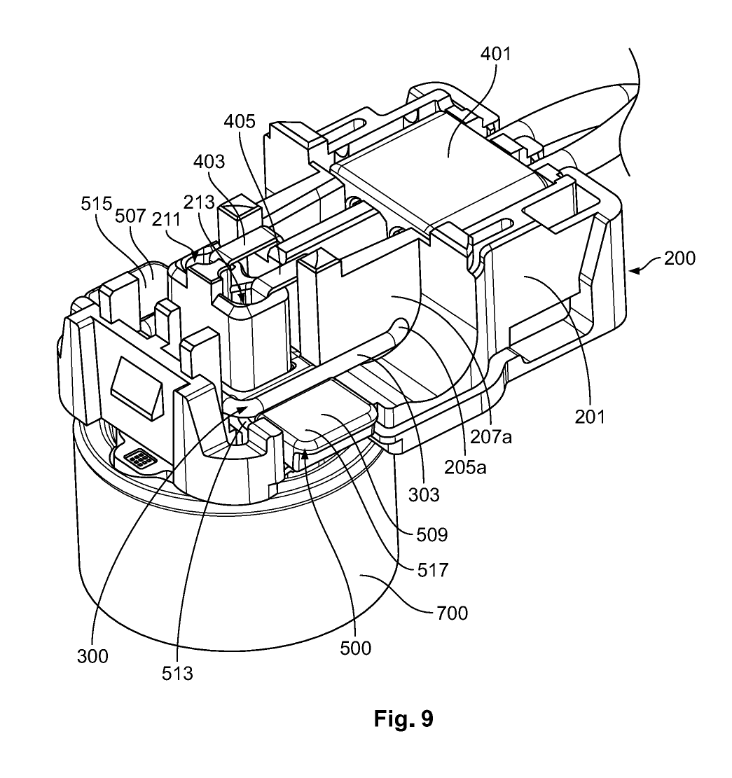

The first position shown in FIG. 7 also corresponds to the position in which the electrical connector 100 is correctly locked onto a mating connector. When the CPA device 500 is inserted sufficiently fully in such a way as to be locked onto the mating connector, the spring 300 returns to its unstressed state and the first position, as described below with respect to FIG. 9.

The electrical connector 100 as shown in FIG. 8 is in a second position in which the spring 300 is loaded. The second position is a step where coupling has been initiated, but not yet completely finalized, between the connector 100 and a mating connector.

During a plugging operation, the CPA device 500 positioned at the connection part 203 is pushed by the mating connector into the main part 201 of the housing 200 towards the cover 600 in the direction indicated by the arrow 2. The direction indicated by the arrow 2 also corresponds to the direction of the misalignment of the two ends 307, 309 of the spring 300. The displacement of the connector position assurance element 500 thus takes place in the same direction as the misalignment of the two ends 307, 309 of the spring 300.

In being displaced, the CPA device 500 pushes the lateral parts 303, 305 of the spring 300 in a resilient manner at the grooves 511, 513, as shown in FIG. 8. Stressed in this way, the spring 300, the ends 307, 309 of which are misaligned, behaves like a torsion spring. In this loaded state, the torsion spring 300 exerts a force on the CPA device 500 in the coupling direction 1 of the connector 100.

If the coupling movement is not continued, or the force exerted for coupling the two connectors has not been sufficient to produce the locking of the electrical connector 100 with its mating connector, the locking prongs 503, 505 of the CPA device 500 are not flexed by the mating connector in such a way that the CPA device 500 can be inserted fully into the mating connector. The mating connector is then automatically ejected in the direction 1 by the CPA device 500 under the effect of the load of the torsion spring 300. Thus, an incomplete or incorrect connection is prevented.

Conversely, if the force exerted for coupling the two connectors is sufficient for producing the locking of the electrical connector 100 with its mating connector, the CPA device 500 is pushed back to the maximum extent by the mating connector into the main part 201 of the housing 200. In being displaced in the direction 2 shown in FIG. 8, the CPA device 500 carries the load of the spring 300 since the spring 300 is displaced from its position of equilibrium. The loaded spring 300 then exerts a force on the CPA device 500 in the coupling direction 1 opposite that of the displacement of the CPA 500 pushed by the mating connector, so as to return towards its position of equilibrium. Given that the connectors are coupled and locked onto each other, the locking prongs 503, 505 of the CPA device 500 are flexed by the mating connector. The CPA device 500 is then capable of being inserted fully at the connection part 203 of the housing 200 into the mating connector under the pressure exerted by the loaded torsion spring 300. The electrical connector 100 is thus correctly locked onto the mating connector and the connector position assurance element 500 is blocked by complementarity of shape with the mating connector. The spring 300 then returns to its unstressed or pre-loaded state corresponding to the first position shown in FIG. 7.

The electrical connector 100 is shown in FIG. 9 in the first position when it is coupled and locked onto a mating connector. In FIG. 9, the electrical connector 100 is correctly locked onto a mating connector 700. The CPA device 500 has been inserted sufficiently in such a way as to be locked onto the mating connector 700 by complementarity of shape. The spring 300 is in an unstressed state and is in the first position as described in FIG. 7.

What is claimed is:

1. A electrical connector, comprising:
a housing; and
a spring mounted on the housing, the spring is a shaped-wire spring having a pair of ends that are mounted on the housing in an axially offset manner in relation to one another, a misalignment of the ends of the spring forms a torsion spring.

2. The electrical connector of claim 1, wherein the ends of the spring are axially offset parallel to one another.

3. The electrical connector of claim 1, wherein the spring is U-shaped, having a central part perpendicular to a pair of lateral parts.

4. The electrical connector of claim 3, wherein the ends of the spring are connected to the lateral parts and extend perpendicularly to the lateral parts.

5. The electrical connector of claim 1, wherein the spring is horseshoe-shaped, V-shaped, or arc-shaped, having a central part and a pair of lateral parts provided with the ends of the spring.

6. The electrical connector of claim 3, wherein the lateral parts have different lengths.

7. The electrical connector of claim 1, further comprising a connector position assurance element adapted to lock the electrical connector to a mating connector when the electrical connector is correctly connected to the mating connector.

8. The electrical connector of claim 7, wherein the connector position assurance element is capable of being displaced in a same direction as the misalignment of the ends of the spring.

9. The electrical connector of claim 7, wherein the connector position assurance element is in contact with the spring.

10. The electrical connector of claim 9, wherein the electrical connector is in a first position when separated from the mating connector and when correctly connected and locked to the mating connector.

11. The electrical connector of claim 10, wherein, in a second position of the electrical connector coupled but not locked to the mating connector, the spring exerts a force on the connector position assurance element in a coupling direction of the connector with the mating connector, moving the connector position assurance element into the first position upon completion of coupling the electrical connector to the mating connector.

12. The electrical connector of claim 11, wherein the spring is in a pre-loaded state in the first position and exerts a force on the connector position assurance element in the coupling direction.

13. The electrical connector of claim 10, wherein the connector position assurance member is blocked by complementarity of shape with the mating connector when the electrical connector is correctly connected and locked onto the mating connector.

14. The electrical connector of claim 9, wherein the connector position assurance element has a pair of grooves accommodating the spring.

15. The electrical connector of claim 1, wherein the electrical connector is a primer connector for a safety restraint system of a motor vehicle.

16. A housing for an electrical connector, comprising:
a pair of recesses misaligned with one another and adapted to receive a pair of ends of a shaped-wire spring of the electrical connector.
